(19) United States
(12) Patent Application Publication
(10) Pub. No.: US 2001/0043613 A1
(43) Pub. Date: Nov. 22, 2001

(54) Method and system for resource allocation in broadband wireless networks

(76) Inventors: Eko Adi Wibowo, Ottawa (CA); Jun Huang, Ottawa (CA); David Turpin, Orleans (CA)

Correspondence Address: Seidel, Gonda, Lavorgna & Monaco, P.C., Suite 1800, Two Penn Center Plaza, Philadelphia, PA, 19102, US

(21) Appl. No.: 09/802,667

(22) Filed: Mar. 9, 2001

(30) Foreign Application Priority Data
Mar. 20, 2000 (CA) 2,301,394
Sep. 26, 2000 (CA) 2,320,734

(51) Int. Cl. H04J 3/16; H04J 3/22

(52) U.S. Cl. 370/468

(57) ABSTRACT

A system and method for resource allocation in a broadband telecommunications network operating under CF-DAMA. Data-slot credits for each terminal are accumulated, once all CRA and RBDC bandwidth reservations have been satisfied. These credits represent the prioritized segment of the terminal's VBDC bandwidth request and are used by a resource allocation server within the base station of the network to prioritize the VBDC allotment of data slots to that terminal. Once the terminal's VBDC credits have been used, the resource allocation server attempts to satisfy the remaining un-prioritized VBDC bandwidth request, but will only do so if data slots are still available after all of the CRA and RBDC reservations and all VBDC credits of the given terminal have been accommodated.

### FIELD OF THE INVENTION

The present invention generally relates to multi-user broadband wireless networks, and in particular, to a resource allocation in broadband wireless networks, such as CF-DAMA communications systems.

### BACKGROUND OF THE INVENTION

In today's ever-expanding telecommunications market, broadband wireless communication networks must support a diversity of new applications and provide numerous types of services, such as bandwidth-on-demand and the exploding internet traffic. These requirements have brought about advanced techniques for handling current communication traffic conditions characterized as being very bursty and unpredictable.

In modern multi-user broadband networks (such as that shown in FIG. 1 where a large number of user terminals share a common communication link with a base station or hub), it is necessary to allocate different portions of time and frequency to the transmission of data from each terminal in order to prevent interference between messages that are communicated simultaneously throughout the network. Furthermore, in order to maximize bandwidth utilization in the network, it is desirable that only those terminals that need to send data to the base station should have access to the network bandwidth capacity (thus the term “Bandwidth-on-Demand”). This is achieved by introducing multiple access protocols—a process that usually consists of both primary and secondary multiple access methods.

The primary multiple access methods relate mainly to bandwidth utilization. These are commonly known as Frequency Division Multiple Access (FDMA), Time Division Multiple Access (TDMA), and Code Division Multiple Access (CDMA). More recently, variant combinations of these three schemes have surfaced. One of the combinations is Multi-Frequency Time Division Multiple Access (MF-TDMA)—a frame-based protocol structure whose transmission bandwidth is divided into both frequency and time slots, as shown in FIG. 2. Under this multiple access scheme a user terminal can transmit its message at different carrier frequencies and during any time slot. However, in order to minimize power output and reduce hardware complexity, a terminal typically does not transmit a data slot on more than one frequency at a time.

Time-frequency slots in the MF-TDMA frame are typically grouped according to the data transfer process and generally classified into five functional groups, namely: log slots, used in the registration or log-in process; acquisition slots, which are used by the user terminals to secure synchronization with the base station; synchronization slots, used by the user terminals to maintain synchronization with the network timing; request slots, which carry bandwidth request information from each user terminal; and data slots, used to transfer the actual network traffic.

The secondary multiple access methods govern the process for using the above request and data slots. One of these protocols is the Combined Free-Demand Assignment Multiple Access which was first introduced in J. I. Mohammed, “Combined Free/Demand Assignment Multiple Access Protocols for Packet Satellite Communications”, Thesis, Concordia University, Montreal, Canada, Chap. 3, June 1993. Protocols in this category first distribute the transmission bandwidth allocation based on requests made by the user terminals. Following this process, unrequested bandwidth is then distributed to each terminal for as long as there remains unused capacity in the network. CF-DAMA protocols have the advantage of maximizing bandwidth utilization while, at the same time, providing network robustness, controlled fairness and stable operation up to very high traffic loads.

To date, a variety of CF-DAMA protocols have been conceived. An exemplary method is described in E. A. Wibowo, A. Iuoras, P. Takats, J. Lambadaris and M. Devetsikiotis, “Guaranteeing Quality of Service in Packet-Switched Satellites by Medium Access Control”, Proceedings of the CCBR'98 Conference, Ottawa, Canada, Jun. 21-24, 1998. This method makes use of four types of request handling assignments, namely: Constant Rate Allocation (CRA), Rate-base Dynamic Capacity (RBDC) allocation, Volume-based Dynamic Capacity (VBDC) allocation, and Free Capacity Assignment (FCA).

In the CRA assignment method a user terminal states its requirement for network capacity at connection set-up time and, in response, the network controller (otherwise known as the resource allocation server) allocates to the terminal the requested number of data slots per frame for each and every frame during the connection. This constant rate assignment is aimed at real-time connections, such as the Continuous Bit Rate (CBR) and the Real-time Variable Bit Rate (RT-VBR) classes of service, which cannot tolerate delay and delay variations.

In the RBDC assignment method a user terminal may request a variable number of data slots in each frame and, in response, the resource allocation server guarantees that the RBDC request will be granted up to a maximum value negotiated at connection set-up time. This assignment strategy is designed for non-real-time connections that can tolerate delay, such as the non-real-time variable Bit Rate (nrt-VBR) and the Available Bit Rate (ABR) classes of service. In contrast to CRA, the RBDC strategy allows for statistical multiplexing among terminals, resulting in a more efficient use of the network resources.

In the VBDC assignment method a user terminal requests network capacity in terms of the total number of data slots needed to empty its data queue. In this case, the resource allocation server does not provide a guarantee on capacity availability but tries its best to satisfy the terminal's request. The VBDC assignment remains effective as long as the requested data slots can be granted or as long as the assignment has not timed out. This third assignment technique is directed at jitter-tolerant connections, such as bursty traffic.

Finally, in the FCA assignment method the resource allocation server only attempts to maximize network capacity utilization by distributing unrequested network capacity to all of the registered terminals. This assignment strategy ranks the lowest amongst the four assignment categories and, unlike the previous three, user terminals have no control in obtaining network capacity.

In the method of Wibowo et al., above, the resource allocation server calculates the number of data slots it will reserve for the CRA and RBDC assignments, then it determines the number of data slots that have been requested for VBDC assignment. Following these calculations, the resource allocation server assigns to each terminal its guaranteed CRA and RBDC data slots. Then it attempts to satisfy each terminal's VBDC requests. Finally, it freely assigns one payload slot to each terminal as long as there remains unused capacity. Moreover, the resource allocation server selectively assigns unused capacity, that is, terminals having no assignments in a frame are given higher priority to receive free assignment of unused capacity than those with CRA, RBDC or VBDC assignments.

While the techniques described in Wibowo et al. are designed to support multiple classes of service and maintain Quality of Service (QoS) guarantees, the attempt to fully satisfy each terminal's VBDC request reduces the number of terminals that can receive bandwidth allocation in each frame. This obstacle produces two disadvantages: it increases short traffic burstiness (thereby increasing congestion loss) and it increases data transfer delay at high traffic loads.

One method of resolving the above shortcomings is described in Jun Huang, Tho Le-Ngoc and Jeremiah F. Hayes, “Broadband Satcom System for Multimedia Services”, Proceedings of the ICC'96 Conference, pp.906-910, 1996, where tokens are used to determine the number of data slots that should be allotted to each terminal. Here, each terminal is periodically granted a token, based on its requested service rate. When a terminal makes a VBDC bandwidth request, the resource allocation server attempts to allocate data slots based on the number of tokens the terminal has accumulated. While this strategy reduces traffic burstiness, congestion loss, and data transfer delays at high traffic loads, it unfortunately does not attempt to maximize bandwidth utilization—even if bandwidth capacity is available after all accumulated tokens from all terminals have been exhausted. Moreover, this method does not grant free assignment of data slots.

Another method of resolving the shortcomings of the method of Wibowo et al., above, is described in G. Açar and C. Rosenberg, “Algorithms to Compute Bandwidth on Demand Requests in a Satellite Access Unit”, Proceedings of the Fifth Ka-Band Utilization Conference, Taormina, Sicily, Oct. 18-20, 1999, where each terminal is granted a fair share of the best-effort bandwidth after reserved bandwidth assignments for static rate (similar to CRA) and booked rate (similar to RBDC) have been satisfied. Here, the resource allocation server considers granting a best-effort share of bandwidth to a terminal only if the terminal has requested more data slots than its booked rate. While this method strongly supports service fairness, its attempt to distribute best-effort bandwidth fairly requires lengthy operations to maximize bandwidth utilization in situations where the number of pending requests from each terminal varies appreciably.

It is therefore desirable to provide a resource allocation method that distributes substantially more bandwidth through the VBDC assignment strategy to all user terminals under high traffic load conditions. It is further desirable to provide a resource allocation method that distributes unreserved bandwidth through the VBDC and FCA assignment strategies to all user terminals in a fair and equitable manner in order to reduce delays in access requests and cell transfer.

### SUMMARY OF THE INVENTION

It is an object of the present invention to obviate or mitigate at least one disadvantage of resource allocation under existing CF-DAMA protocols. Generally, the present invention provides a system and method for resource allocation in a broadband telecommunications network operating under CF-DAMA. Data-slot credits for each terminal are accumulated. These credits represent the prioritized segment of the terminal's VBDC bandwidth request and are used by a resource allocation server within the base station of the network to prioritize the VBDC allotment of data slots to that terminal. Once the terminal's VBDC credits have been used, the resource allocation server attempts to satisfy the remaining un-prioritized VBDC bandwidth request, but will only do so if data slots are still available after all of the CRA and RBDC reservations and all VBDC credits of each terminal have been accommodated.

In a first aspect, there is provided a resource allocation method for allocating data slots to access devices in a broadband telecommunications system operating under CF-DAMA. For each frame, the method first determines a number of reserved data slots for each access device in the network, according to CRA and/or RBDC. VBDC requests are received from the access devices. Next, a maximum prioritized VBDC is determined for each access device, in turn, according to its VBDC request and its accumulated prioritized VBDC credit. The total available capacity for prioritized VBDC is then determined, and prioritized VBDC data slots are allocated to each of the access devices, in turn up to their respective maximum prioritized VBDC capacities, or until the total available capacity is exhausted. The accumulated prioritized VBDC credit for each device is then updated to reflect those credits used, or not, in the frame. The method can also include the allocation of FCA data slots, by maintaining a similar FCA credit for each device.

In a further aspect, the present invention provides a resource allocation system for a broadband telecommunications network operating under a CF-DAMA. The systems, usually located in a baseband section of a base station, includes a circular-linked list that contains resource requirements for access devices in the network. The resource requirements include an accumulated VBDC credit for each of the access devices. A resource allocation server is logically connected to the circular-linked list. The resource allocation server includes means to receive VBDC requests from the access devices, means to scan the circular-linked list to determine the number of reserved data slots for each of the access devices, means to determine a maximum prioritized VBDC for each of the access devices, means to allocate, according to their respective VBDC requests and accumulated prioritized VBDC credits, prioritized VBDC data slots until a total available capacity is exhausted, and, means to update the accumulated prioritized VBDC credits for each of the access devices.

### BRIEF DESCRIPTION OF THE DRAWINGS

Preferred embodiments of the present invention will now be described, by way of example only, with reference to the attached Figures, wherein:

FIG. 1 is a block diagram of a typical multi-user broadband wireless communication network;

FIG. 2 is a block diagram of a base station of the broadband wireless communication network of FIG. 1;

FIG. 3 is a block diagram of a user access device of the broadband wireless communication network of FIG. 1;

FIG. 4 is a circular-linked list of access device entries that are registered in the broadband wireless network;

FIGS. 5 and 6 are flowcharts of the resource allocation method of the present invention;

FIG. 7 is a diagram of a terminal configuration used in simulations of the method of the present invention;

FIGS. 8 to 11 show simulation results for a first simulation of the method of the present invention; and

FIGS. 12-15 show simulation results for a second simulation of the method of the present invention.

### DETAILED DESCRIPTION OF THE INVENTION

Generally, the present invention provides a method and system for use by a resource allocation server for allocating VBDC data slots to user access devices and for distributing unreserved bandwidth fairly to all access devices in a bandwidth-on-demand (BoD) communications network.

While embodiments of the present invention are described herein in terms of broadband wireless networks, the system and method of the present invention are explicitly not limited to wireless applications. They are equally applicable to other telecommunications systems and protocols, and other similar environments employing multiple access technologies, as will occur to those of skill in the art.

The resource allocation method of the present invention is one component of a set of Media Access Control (MAC) protocols and algorithms of a BoD network. In order to understand the functionality and appreciate the importance of a resource allocation method, a high-level knowledge of how such a network operates is beneficial.

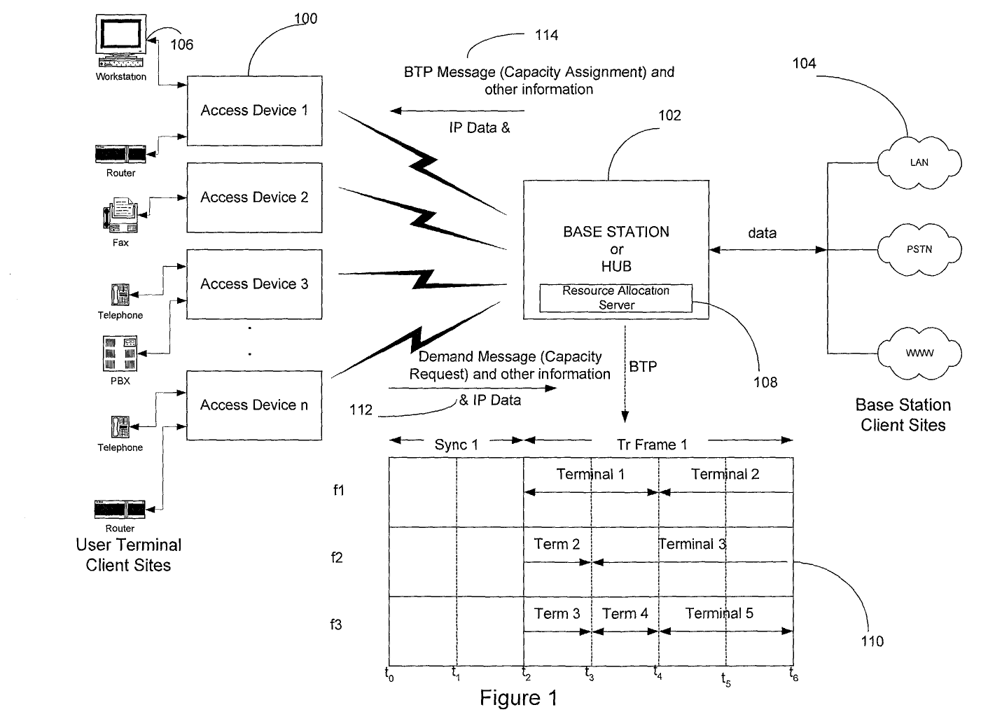

A typical multi-user wireless communication network, such as a BoD network implementing MF-TDMA and CF-DAMA protocols, is illustrated in FIG. 1, and consists of a plurality of user access devices 100, a base station (or hub) 102, a plurality of base station client sites 104, and a plurality of user access device client sites 106. The access devices 100 are typically sharing upstream transmission bandwidth to the base station 102. Therefore, in order to reduce the occurrences of, or avoid, collisions, the base station 102 typically controls access to the transmission bandwidth. Furthermore, in order to achieve high bandwidth utilization, it is advantageous if the base station 102 is capable of granting access to the transmission bandwidth only to devices 100 that need to send data to the base station 102 (the term bandwidth-on-demand is hence used to describe such capability). For the base station 102 to regulate access and provide bandwidth on demand to access devices 100, the following operations are generally necessary:

Each access device 100 computes the number of upstream transmission data slots required to satisfy its traffic requirement.

Each access device 100 signals or requests this calculated number of upstream data slots to the base station 102.

The base station 102 (more specifically, the resource allocation server 108 that is located in the base station), calculates the number of upstream data slots it can grant to each access device 100 based on reservations and/or requests from the corresponding access device 100.

The base station 102 builds and signals to all access devices 100 an assignment table (called burst-time plan or BTP) containing information on the frequencies and times each access device 100 that is granted access can send its data.

Each access device 100 scans each assignment table for information on the frequencies and times it can send its data.

Each access device 100 transmits its data at the specified frequencies and times.

Central to the above operations is the execution of the resource allocation method. Indeed, the resource allocation method significantly influences the attributes of the network, such as maximum sustainable throughput, data transfer delay and fairness.

Residing within the base station 102 is a resource allocation server 108 which prepares and distributes to each of the user access devices a burst time plan (BTP) 110 according to a specified MF-TDMA frame and CF-DAMA protocol. Before a user access device 100 is allowed to use any of the base station clients 104, it must register itself to the network. Once logged on, it synchronizes itself to the network timing so as not to interfere with any of the other access devices. Following synchronization, the access device 100 calculates the amount of bandwidth it needs to satisfy its traffic requirement and transmits its request for upstream data slots (Capacity Request) 112 to the resource allocation server 108. In response to the access device's bandwidth request, the resource allocation server 108 first allocates the appropriate bandwidth via time-frequency slots, which are typically expressed by one or more specified channel frequencies and corresponding time slots (as illustrated in the BTP 110), and then transmits the BTP through a Capacity Assignment message 114 to the corresponding user access device 100. Upon receiving its assignment message, the access device 100 scans each assignment frame for the time/frequency slots it can use and transmits its input data upstream to the base station for follow-on distribution to the respective base station client(s) 104. As well, the base station prepares and transmits its input data downstream to each access device for follow-on distribution to the access device client(s) 106. Following the foregoing process, unreserved data slots in the BTP 110 are freely distributed by the resource allocation server 108 to the user access devices 100 for non-requested bandwidth allocations.

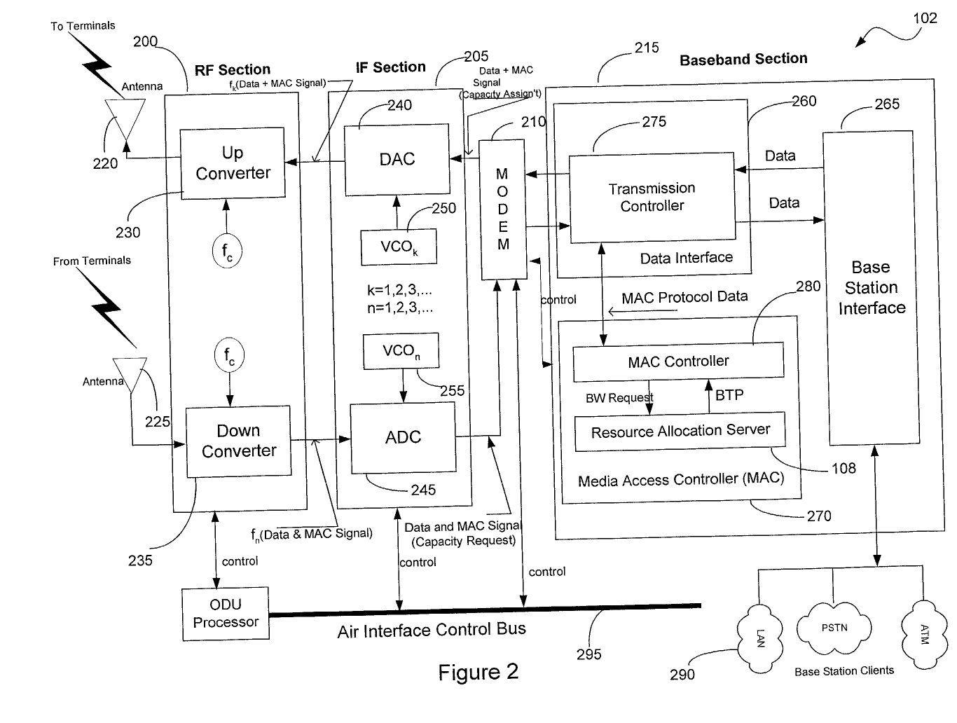

A preferred embodiment of a base station 102 incorporating the present invention is shown in FIG. 2. The base station 102 consists of an RF section 200, an IF section 205, a modem 210, and a baseband section 215. The principle components of the RF section 200 are an up converter 230, a down converter 235 and their respective transmit/receive antennas 220 and 225. The main components of the IF section 205 are a digital-to-analog converter (DAC) 240 together with its voltage controlled oscillator (VCOₖ) 250 and an analog-to-digital converter (ADC) 245 together with its voltage controlled oscillator VCOₙ 255. Residing within the baseband section 215 are a data interface unit 260, a media access controller (MAC) unit 270 and a base station interface unit 265. Within the data interface unit 260 is located a transmission controller 275, and within the MAC unit 270 are located a MAC controller 280 and a resource allocation server 108. Interconnecting the RF, IF and baseband sections is an air interface control bus 295 that, in part, applies control signals to/from the sections according to the protocols established by the resource allocation methods of the present invention.

The resource allocation method of the present invention operates in the resource allocation server 108. This server 108 receives bandwidth capacity requests from a plurality of network access devices 100 and allocates to each of these access devices 100 a separate bandwidth capacity assignment according to a burst time plan (BTP) that regulates the time slots and frequency channels each access device can use. The BTPs are first forwarded to the MAC controller 280, which controls the flow of messages between the base station 102 and user access devices 100, then sent to the transmission controller 275 under a MAC layer protocol. The transmission controller 275 controls the transmission of data traffic and MAC messages to/from the modem 210, and data traffic to/from the base station interface 265. The message sent to the modem 210 consists of the MAC signal (BTP) from the MAC controller 280 and data traffic from the base station interface 265. The message received from the modem 210 consists of the MAC signal (capacity request), other data, and data traffic from the network access devices 100.

Upon receiving this latter message, the transmission controller 275 determines whether it should be forwarded to the base station interface 265 or the MAC controller 280.

When the base station 102 transmits data and MAC signals, the IF section 205 performs digital-to-analog conversion of the out-bound modulated message from the modem 210. Here the DAC 240 and its associated VCOₖ 250 combine the dc message with a plurality of frequency channels, each designated to a particular user access device 100 in the wireless network. The modulated IF message is then up-converted by the up converter 230 to the centre transmission frequency of the base station 102 for onward transmission via antenna 220 to all of the access devices 100 in the wireless network. On the receiving end, data and MAC (capacity request) signals from the user access devices 100 are received at antenna 225 and down-converted by the down converter 235 to the IF band. Here each access device's allotted channel frequency (fₙ) is separated from the received message by the ADC 245 and its associated VCOₙ 255. The resulting dc message is then demodulated by the modem 210 and forwarded to the transmission controller 275. From here data traffic is sent to the base station interface 265 and the MAC (capacity request) signal is forwarded to the resource allocation server 108, via the MAC controller 280, for processing.

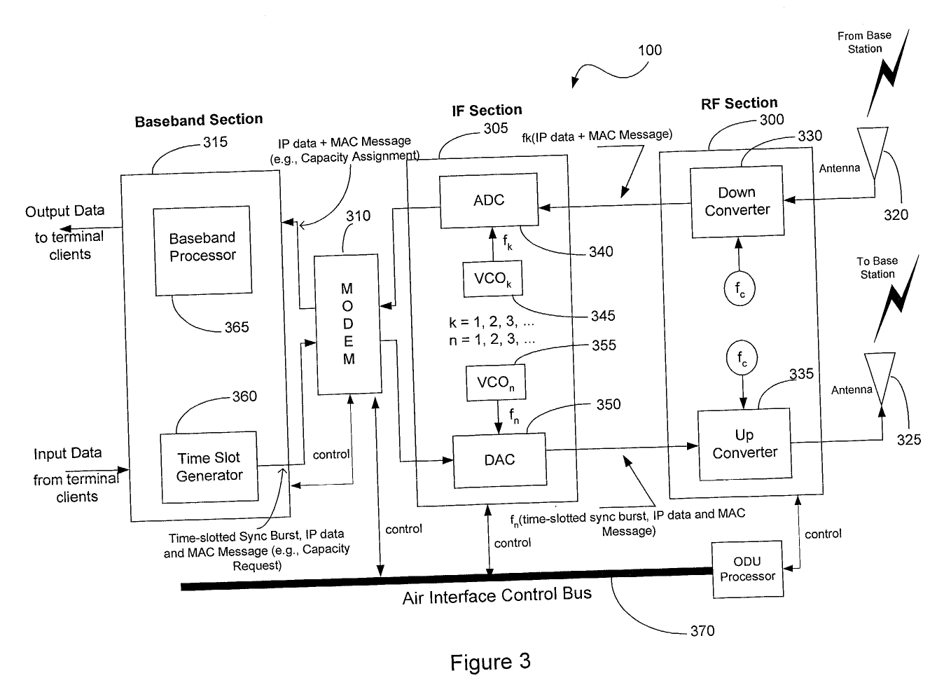

A preferred embodiment of an access device 100 for operation under the resource allocation method of the present invention is illustrated in FIG. 3. Similar to the base station described in FIG. 2, the access device consists of an RF section 300, an IF section 305, a modem 310, and a baseband section 315. The principal components of the RF section 300 are a down converter 330, an up converter 335 and their respective receive/transmit antennas 320 and 325. The main components of the IF section 305 are an analog-to-digital converter (ADC) 340 together with its associated voltage controlled oscillator VCOₖ 345 and a digital-to-analog converter (DAC) 350 together with its voltage controlled oscillator VCOₙ 355. The principal components of the baseband section 315 are a baseband processor 365 and a time slot generator 360. Interconnecting the RF, IF and baseband sections is an air interface control bus 370 that, in part, applies control signals to and from the said sections according to the protocol established by the resource allocation method of the present invention.

Generally, the signal from the base station 102 is received by antenna 320, down-converted from its centre frequency by the down converter 330, and forwarded to the IF section 305. Here the base station's assigned channel frequency (fₖ) is separated from the received signal by the ADC 340 and its associated VCOₖ 345 and forwarded to the modem 310. Following demodulation, the received dc signal is sent to the baseband section 315 for processing. Within this section, the baseband processor 365 is responsible, in part, for (a) controlling the transmission of the data traffic to/from the access device's clients, (b) calculating the amount of bandwidth needed to satisfy the access device's traffic requirement, (c) forwarding the MAC (Capacity Assignment) message to the time slot generator 360 in conformance with the BTP generated by the resource allocation server 108 of FIG. 2, and (d) controlling the preparation of the access device's MAC (Capacity Request) message. The time slot generator 360 prepares and transmits to the modem 310 (a) the time-slotted Sync burst and input data traffic message or (b) the access device's MAC (Capacity Request) message (in conformance with the received BTP message). Following modulation, the out-bound dc message is combined with the access device's assigned channel frequency (fₙ) by the DAC 350 and associated VCOₙ 355 and forwarded to the RF section 300 where the time/frequency message is up-converted to the access device's centre frequency and transmitted to the base station 102 via antenna 325.

The resource allocation server 108 is responsible for distributing upstream transmission data slots based on requests from wireless access devices 100. In distributing upstream data slots, the resource allocation server 108 must guarantee that it can allocate to each access device 100 the number of data slots that has been reserved for the device. The resource allocation server 108 is free to distribute, using VBDC and FCA, any upstream data slots unassigned after servicing all slot reservations (i.e., data-slot reservations through CRA and RBDC). The resource allocation server 108, however, should be fair in distributing these unreserved data slots as service fairness brings about many advantages, including reductions in request access delays, reductions in cell transfer delays, and increased traffic shaping effect.

The resource allocation method of the present invention will now be described. Generally, the resource allocation method of the present invention concerns the treatment of VBDC requests and the distribution of FCA. The resource allocation method treats VBDC requests for a given access device as having two components, a prioritized VBDC component and a normal VBDC component. Additionally, the method uses a more sophisticated method of granting FCA to access devices than has previously been proposed.

According to the resource allocation method of the present invention, each access device 100 can be given a number of data-slot credits by the resource allocation server 108 at every frame. The number of credits the resource allocation server 108 grants in every frame to an access device 100 is typically equivalent to the service rate requested by the access device 100. These credits are accumulated and form the prioritized VBDC component of the corresponding access device 100. The resource allocation server 108 uses accumulated VBDC credits of a given access device 100 in order to determine the access device's prioritized VBDC assignment.

The normal VBDC component of a given access device 100 is equivalent to the number of data slots requested by the access device 100 through VBDC less the access device's prioritized VBDC component. The resource allocation server 108 will only attempt to satisfy the normal VBDC component of a given access device 100 when free data slots are available after the resource allocation server 108 satisfies all data slot reservations and the prioritized VBDC component of each access device 100.

Finally, if upstream data slots are available after the resource allocation server 108 satisfies slot reservations, prioritized VBDC components and normal VBDC components of all access devices 100, the resource allocation server 108 attempts to distribute unassigned data slots through FCA. Similar to the approach for providing a prioritized VBDC component, each access device 100 can be given a number of data-slot credits by the resource allocation server 108 at every frame for FCA. The resource allocation server 108 uses accumulated FCA credits of a given access device 100 in order to determine the number of free data slots it can grant to the access device 100. Additionally, the resource allocation server 108 applies a threshold to the number of data slots that will be assigned to the access device 100 due to its slot reservation and its VBDC assignment, above which the resource allocation server 108 will not consider granting free data slots to the corresponding access device 100.

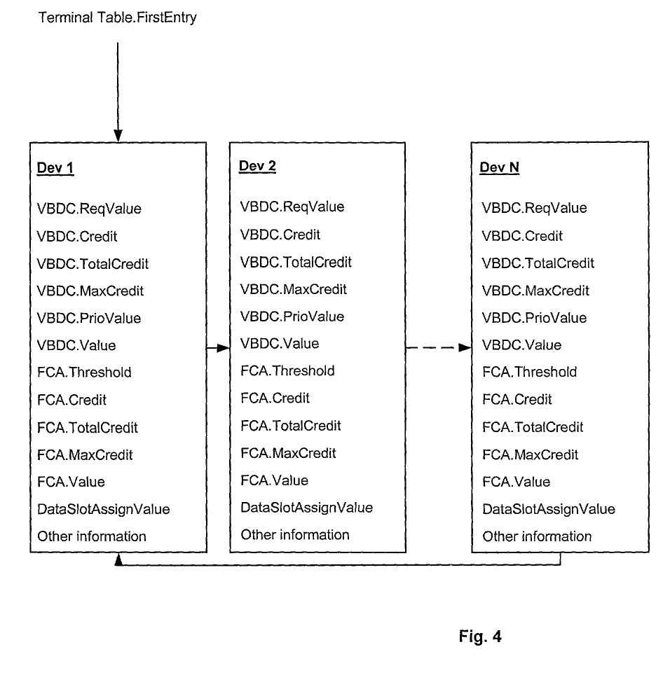

The resource allocation server 108 maintains an access device table that contains information on each user access device 100 registered in the wireless network, as shown in FIG. 4. This table contains an arrangement of access device entries in the form of a circular-linked list, wherein each entry holds the resource, or bandwidth, requirement of the respective access device 100. The table is accessed in two stages. In the first stage, the resource allocation server 108 scans the table and calculates the total number of data slots it needs to accommodate the CRA and RBDC reservations, and the VBDC assignment requests. In the second stage, the resource allocation server 108 re-scans the table and assigns data slots to each access device. The scanning of the table is performed in a “round-robin” fashion, such that all access devices 100 entered in the table are visited in succession, starting from the first access device through to the last, and then repeated.

The following descriptors are used in the attached figures and description to describe the resource allocation method of the present invention:

Requested VBDC value (Dev.VBDC.ReqValue) is the total number of data slots the wireless access device 100 has requested through its VBDC capacity request. This information is updated every time the resource allocation server 108 receives a VBDC request from the access device 100, in which case the new VBDC request value is added to previous requests.

Prioritized VBDC credit (Dev.VBDC.Credit) is the number of data slots (or alternatively, tokens) the wireless access device 100 may accumulate for VBDC at every frame due to unused VBDC credit. Prioritized VBDC credit can be a fractional value if fine token granularity is desired.

Prioritized VBDC total credit (Dev.VBDC.TotalCredit) is the total number of data slots the wireless access device 100 has accumulated for VBDC up to the current frame due to unused VBDC credit.

Prioritized VBDC maximum total credit (Dev.VBDC.MaxCredit) is the maximum total number of data slots the wireless access device 100 can accumulate for VBDC due to unused VBDC credit. This number is typically associated with the maximum volume of data that can be transmitted at the peak rate.

Current Prioritized VBDC value (Dev.VBDC.PrioValue) is the number of data slots the wireless access device 100 can have prioritized access to through VBDC for the considered frame.

Current VBDC value (Dev.VBDC.Value) is the number of data slots the wireless access device 100 can have access to through VBDC for the considered frame.

FCA threshold (Dev.FCA.Threshold) is the threshold on the number of data slots assigned to a wireless access device 100, above which the access device will not be considered for FCA.

FCA credit (Dev.FCA.Credit) is the number of data slots the wireless access device 100 can accumulate for FCA at every frame due to unused FCA credit.

FCA total credit (Dev.FCA.TotalCredit) is total number of data slots the wireless access device 100 has accumulated for FCA up to the current frame due to unused FCA credit.

FCA maximum total credit (Dev.FCA.MaxCredit) is the maximum total number of data slots the wireless access device 100 can accumulate for FCA due to unused FCA credit.

Current FCA value (Dev.FCA.Value) is the number of data slots the wireless access device 100 can have access to through FCA for the considered frame.

Current data slot assignment value (Dev.DataSlotAssignValue) is the number of data slots the resource allocation server 108 will allocate to the wireless access device 100 for the considered frame.

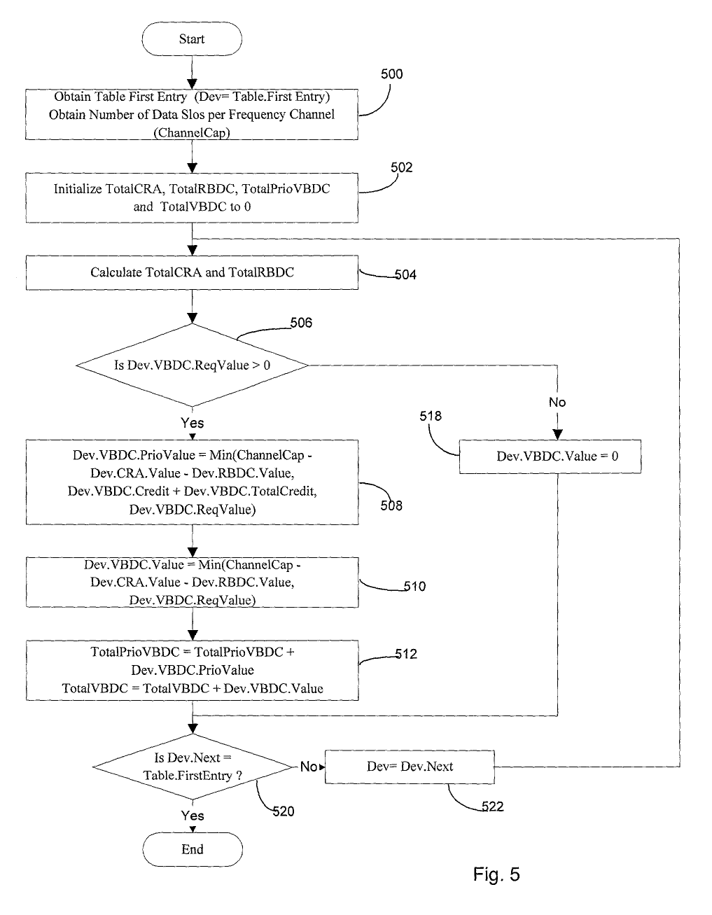

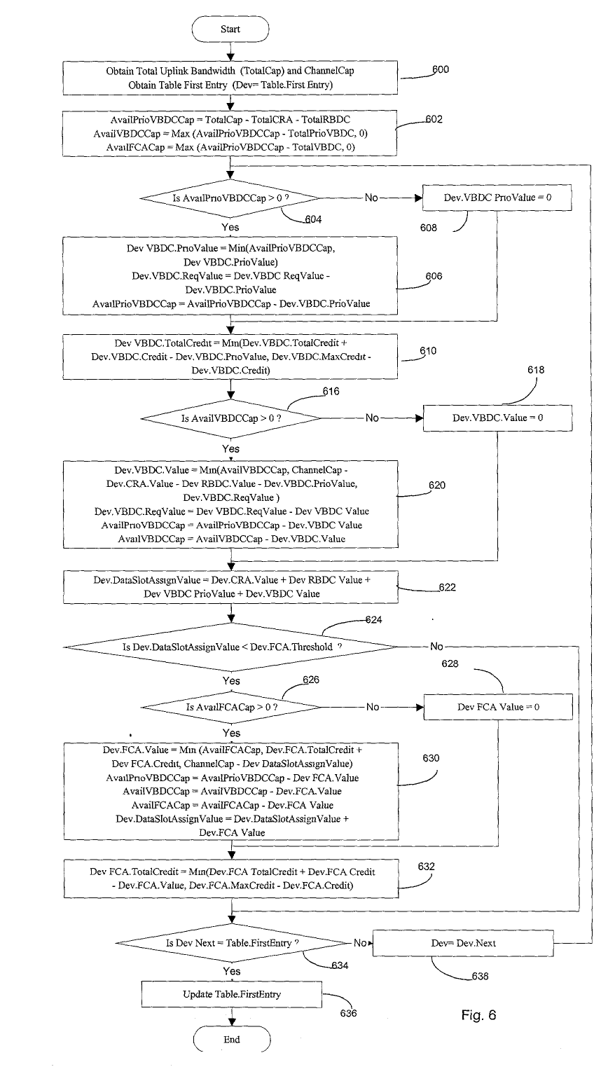

The method of the present invention is illustrated in FIGS. 5 and 6. The flowchart of FIG. 5 illustrates the first scan of the circular-linked table and the determination of the total number of data slots per access device needed to accommodate the CRA and RBDC reservations and the VBDC assignment requests. The method begins at step 500 where the resource allocation server 108 obtains the total number of data slots per frequency channel (ChannelCap) and initializes the first access device (Dev) from the table of FIG. 4. The process then moves to initialization step 502 where the counters for total number of data slots reserved through CRA (TotalCRA) and through RBDC (TotalRBDC), and the counters for total VBDC (TotalVBDC) and prioritized VBDC (TotalPrioVBDC), are initialized to zero.

Following initialization, the process moves to step 504 where the resource allocation server 108 calculates the sum of all data slots reserved through the CRA and RBDC schemes (Dev.TotalCRA and Dev.TotalRBDC). Next, the process moves to decision step 506 where it is determined if the value of the given access device's requested VBDC data slots (Dev.VBDC.ReqValue) is greater than zero. If the response is “No”, the process moves to step 518 where the value of the access device's VBDC data slots (Dev.VBDC.Value) is set to zero, then forwarded to the table entry step 520 where the next access device in the circular-linked list is entered.

Returning to decision step 506, if the response is “Yes”, the process moves to steps 508, 510, and 512 where the resource allocation server 108 calculates both the prioritized VBDC data slots and total VBDC data slots that can be allotted to the access device. Since an access device 100 typically cannot send more data than the channel capacity, the number of prioritized VBDC data slots that can be allotted is determined to be the minimum of (a) the channel capacity minus the number of data slots reserved through the CRA and RBDC schemes, (b) the total amount of prioritized VBDC data slot credits, and (c) the total number of VBDC data slots requested by the access device. Next, the total number of prioritized and un-prioritized VBDC data slots that can be allotted to the access device by the resource allocation server is calculated as the minimum of (a) the channel capacity minus the reserved CRA and RBDC data slots, and (b) the total number of VBDC data slots requested by the access device. Therefore, at step 508, the device prioritized VBDC value Dev.VBDC.PrioValue is the minimum of ChannelCap−Dev.CRA.Value−Dev.RBDC.Value; Dev.VBDC.Credit+Dev.VBDC.TotalCredit; and Dev.VBDC.ReqValue. And, at step 510, the number of prioritized and un-prioritized VBDC data slots (Dev.VBDC.Value) is calculated as the minimum of ChannelCap−Dev.CRA.Value−Dev.RBDC.Value; and Dev.VBDC.ReqValue. Following which the process moves to steps 512 where the resource allocation server 108 updates the total number of data slots for the prioritized VBDC allocation (TotalPrioVBDC=TotalPrioVBDC+Dev.VBDC.PrioValue), as well as the total number of data slots for the total VBDC allocation (TotalVBDC=TotalVBDC+Dev.VBDC.Value).

Following this update, the process moves to the table entry step 520 where the next access device (Dev.Next) in the circular-linked list is selected, and it is determined if the circular-linked list has made full circle and returned to the first table entry. If the response is “Yes”, the process is ended. If “No”, the next access device becomes the current access device at step 522, and the process returns to step 504 where it starts anew for the next access device listed in the table.

The flowchart of FIG. 6 illustrates the second stage of the process, namely, the re-scanning of the circular-linked table and the assignment of data slots to each access device. The following is a description of the second-stage operation.

The process for the second stage is entered at initialization step 600 of FIG. 6 where the resource allocation server 108 first obtains the total up-link bandwidth (TotalCap) and the total channel bandwidth (ChannelCap), then initializes the first table entry (Dev). The process then moves to step 602 where the resource allocation server calculates the available capacity for each of the prioritized VBDC, un-prioritized VBDC, and FCA assignments. Next, the process moves to decision step 604 where it is determined if the available prioritized VBDC capacity is greater than zero. If the response is “No”, the process moves to step 608 where the prioritized VBDC value of the given access device is set to zero, then moves to step 610.

Returning to decision step 604, if the response is “Yes”, the process moves to step 606 where the resource allocation server 108 determines the number of data slots to be allotted to the given access device through the prioritized VBDC assignment scheme. The number of data slots so allotted is determined by the minimum of (a) the access device's prioritized VBDC value, and (b) the available capacity for the prioritized VBDC assignment (Dev.VBDC.PrioValue=Min (AvailPrioVBDCCap, Dev.VBDC.PrioValue)). The resource allocation server 108 then updates the number of data slots remaining from the access device's VBDC capacity request (Dev.VBDC.ReqValue=Dev.VBDC.ReqValue−Dev.VBDC.PrioValue), as well as the number of data slots that are still available for prioritized VBDC assignment, (AvailPrioVBDCCap=AvailPrioVBDCCap−Dev.VBDC.PrioValue).

Next, the process moves to step 610 where the resource allocation server 108 calculates the total number of credits available to the access device for prioritized VBDC assignment as the minimum of the current total number of credits less the credits already used for the access device's prioritized VBDC assignment and the maximum number of credits that may be accumulated by the access device for the subsequent frame (Dev.VBDC.TotalCredit=Min(Dev.VBDC.TotalCredit+Dev.VBDCCredit−Dev.VBDCPrioValue, Dev.VBDCMaxCredit−Dev.VBDCCredit)).

Following the prioritized VBDC calculations, the process moves to decision step 616 where it is determined if the available un-prioritized VBDC capacity is greater than zero. If the response is “No”, the process moves to step 618 where the un-prioritized VBDC value of the given access device is set to zero, and then continues at step 622. Returning to decision step 616, if the response is “Yes”, the process moves to step 620 where the resource allocation server 108 determines the number of data slots to be allotted to the given access device through the un-prioritized VBDC assignment scheme, which is the minimum of (a) the number of data slots available for un-prioritized VBDC assignment (AvailVBDCCap), (b) the channel capacity less the number of data slots allotted to the access device through the CRA, RBDC, and prioritized VBDC assignment schemes (ChannelCap−Dev.CRA.Value−Dev.RBDC.Value−Dev.VBDC.PrioValue), and (c) the remaining data slots from the access device's VBDC request (Dev.VBDC.ReqValue). The resource allocation server 108 then updates the number of data slots remaining from the access device's VBDC capacity request (Dev.VBDC.ReqValue=Dev.VBDC.ReqValue−Dev.VBDC.Value), as well as the number of data slots still available for prioritized VBDC assignment (AvailPrioVBDCCap=AvailPrioVBDCCap−Dev.VBDC.Value), and the number of data slots for VBDC assignment (AvailVBDCCap=AvailVBDCCap−Dev.VBDC.Value).

Next, the process moves to step 622 where the resource allocation server determines the current total number of data slots it will assign to the given access device (Dev.DataSlotAssignValue=Dev.CRA.Value+Dev.RBDCValue+Dev.VBDC.PrioValue+Dev.VBDC.Value). Following this calculation, the process moves to decision step 624 where it is determined if the current value of the total number of data slots to be assigned to the given access device is less than the access device's FCA threshold. If the response is “No”, the process moves to step 634 and the next access device in the table is entered.

Returning to decision step 624, if the response is “Yes”, the process moves to decision step 626 where it is determined if the available FCA capacity is greater than zero. If the response is “No”, the process moves to step 628 where the FCA value of the given access device is set to zero, then moves to step 632. Returning to decision step 626, if the response is “Yes”, the process moves to step 630 where the resource allocation server is free to grant unassigned data slots to the given access device (Dev.FCA.Value) up to the given access device's accumulated FCA credits if such number is less than the access device's FCA threshold. The number of data slots that can be assigned through the FCA scheme is bounded by the channel capacity less the current total number of data slots assigned to the access device (ChannelCap−Dev.DataSlotAssignValue). Once free capacity is assigned to the access device, the resource allocation server updates the number of data slots still available for prioritized VBDC, un-prioritized VBDC, and FCA assignments. As well, the resource allocation server updates the current total number of data slots allotted to the access device for the given frame. Following these updates, the process moves to step 632 where the resource allocation server calculates the total number of credits available to the access device for FCA assignment, which is the minimum of (a) the current total number of FCA credits less the number already used for FCA assignment (Dev.FCA.TotalCredit+Dev.FCA.Credit−Dev.FCA.Value), and (b) the maximum number of credits that may be accumulated by the access device for the subsequent frame (Dev.FCA.MaxCredit−Dev.FCA.Credit).

After this procedure, the process moves to step 634 where it is determined if the next access device in the circular linked linked list is the first access device. If this is true, the process proceeds to step 636 updates Table.FirstEntry, and ends. If the answer is “No”, the current access device is set to the next access device in the list (Dev=Dev.Next) at step 638, and the process returns to decision step 604 where it recommences for the next table entry.

As mentioned above, at step 636, the resource allocation server updates the first entry of the table. The particular strategy for updating the first entry of the table is not shown in FIG. 6. In order to complete the resource allocation method, however, one can, for example, implement a table update strategy similar to that described in E. A. Wibowo et al., above.

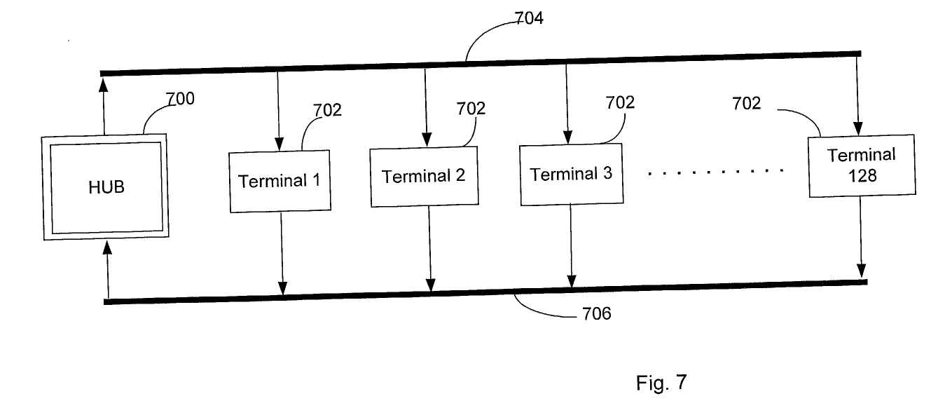

Performance evaluations of the method and system of the present invention were conducted through discrete-event simulations. A simulation network model, composed of one hub node 700 and 128 wireless access nodes 702, similar to the network model shown in FIG. 7, was used. The hub 700 transmits data on the forward channel, represented by a bus link 704. Each of the wireless access nodes is connected to the forward bus link so that each can receive all data sent by the hub. Each of the wireless access nodes is also connected to the return channel(s), represented also by a bus link 706. The hub 700 is also connected to the return bus link 706 so that it can receive all data generated by each wireless access node 702. The propagation delay between the hub 700 and the closest access device node 702 is approximately 250 msec, while the propagation delay between the hub 700 and the furthest access device node 702 is approximately 255 msec.

The frame structure for each of the simulations is similar. Each superframe is composed of 32 frames, where each frame is approximately 26 ms in duration, consisting of two frequency channels with 16 synchronization slots and 128 traffic slots per channel. The effective data rate for each channel is approximately 1.9 Mbps. Next, each simulation is conducted for a simulated time of 350 seconds. Simulation statistics, however, are collected starting from a simulated time of 50 seconds.

Two scenarios are used to demonstrate the superior performance offered by the VBDC prioritization of the resource allocation method of the present invention. The first simulation scenario is intended to evaluate transfer delay performance offered to traffic generated in the access devices when the novel VBDC prioritization feature is disabled. The second simulation scenario is intended to evaluate performance improvement offered by the novel VBDC prioritization feature. In the second scenario, where the VBDC prioritization feature is enabled, each device's VBDC credit and VBDC maximum credit are set to 1.0 and 4.0, respectively. The credit-based FCA distribution strategy is enabled in both simulation scenarios.

High-priority and low-priority data traffic is generated in both of these scenarios. High-priority data traffic is represented by On-Off packet generators and is handled using VBDC. Low-priority data traffic is represented by WWW packet generators as described in Shuang, Deng, “Empirical Model of WWW Document Arrivals at Access Link”, Conference Record ICC'96, 1996, pp. 1797-1802, and is also handled using VBDC. Within an access device, high-priority data traffic is set to receive up to 75% of data slots assigned to the access device, while low-priority data traffic is set to receive the remaining number of data slots assigned to the device. Next, each access device is eligible for FCA. Furthermore, each device in the network accepts traffic from 1 high-priority data source, for an average load of approximately 6 kbps per access device. The loading of low-priority data traffic in each access device is varied from an average load of approximately 6.5 kbps to an average load of approximately 23.3 kbps. In order to gain sufficient level of confidence in the simulation results, five simulations with different simulation seeds are conducted for each different loading of low priority data traffic.

While the resource allocation method of the present invention has been described generically without reference to a particular CF-DAMA implementation, the simulations below show how it can be incorporated into existing schemes. The delay performance of the resource allocation method of the present method, using three variations of VBDC allocation strategies, is assessed. The first of these is a sample VBDC allocation strategy where the resource allocation server accumulates VBDC requests of each terminal. The second variation is similar to the method described in Wibowo et al., above, but VBDC requests never time-out and only one type of VBDC strategy is supported. In this variation, the hub stores each VBDC request message sent by each wireless access device. A device's entry in the device table includes a list (a FIFO queue) of VBDC requests that have been sent by the device and have not been granted in full by the resource allocation server. Each newly arriving VBDC request from the device will be queued in this VBDC request queue.

There are however two differences between the first variation and the second variation. First, in calculating the number of time-slots requested through VBDC, for each access device, the resource allocation server only considers the oldest (i.e., the top) VBDC request that has not been granted in full. Second, if at the second stage a device's VBDC request cannot be granted in full, the request will still be kept at the head of the device's VBDC request queue. A device's VBDC request will only be removed from the request queue if it has been granted in full.

The third variation is similar to the method described in Acar et al., above, but without the fair distribution of best-effort bandwidth. The third method is also similar to the second method in that the hub stores each VBDC request message sent by each access device. The difference between the third method and the second method is that in the third method an access device's VBDC request that cannot be granted in full will be removed from the device's VBDC request queue and its content added to the subsequent VBDC request in the VBDC request queue.

For each simulation scenario, two figures and two tables are presented. The first figure shows the average packet transfer delay of high-priority data traffic. (The average packet transfer delay is the average delay experienced by a packet from the time it arrives at a wireless access device to the time it is received by the hub.) The second figure shows the average packet transfer delay of low-priority data traffic. Each figure is set to show the range of packet transfer delay at 95% confidence interval. Since the range of average delay values is very small compared to the mean of average delay values, simulations of a given scenario are repeated with different simulation seeds, such that there is a high level of confidence that the average packet transfer delay value is close to the mean of average delay value shown in the corresponding figures. Next, the first and second tables summarize the average access delay of high-priority and low priority data packets, respectively, for each of the three variations. (The average access delay for data packets is computed by subtracting the average one-way propagation delay (from the wireless access device to the hub) from the average packet transfer delay.)

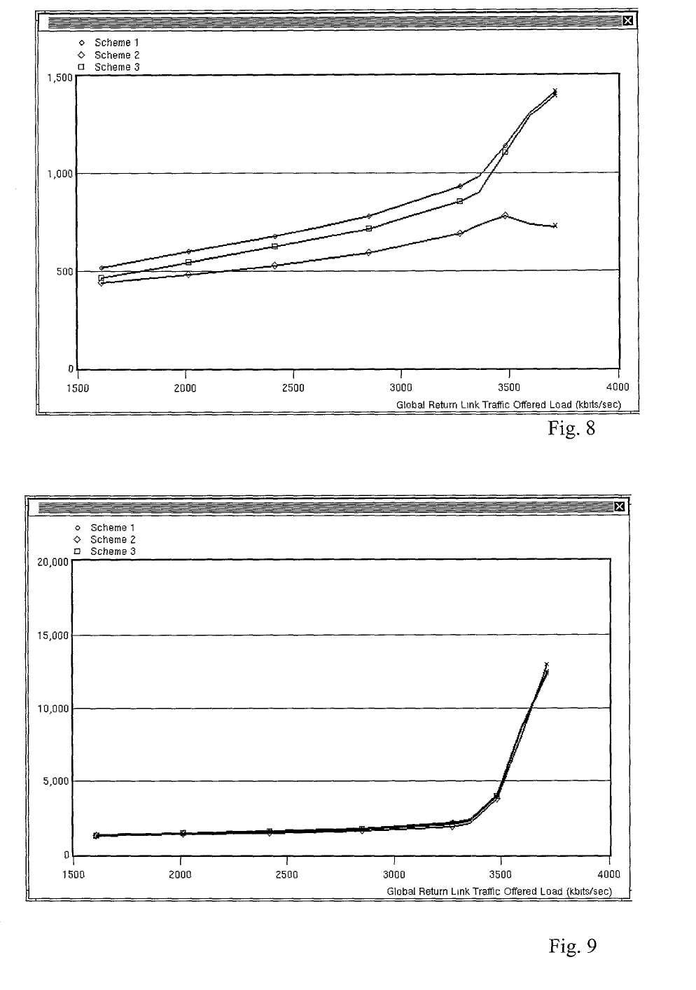

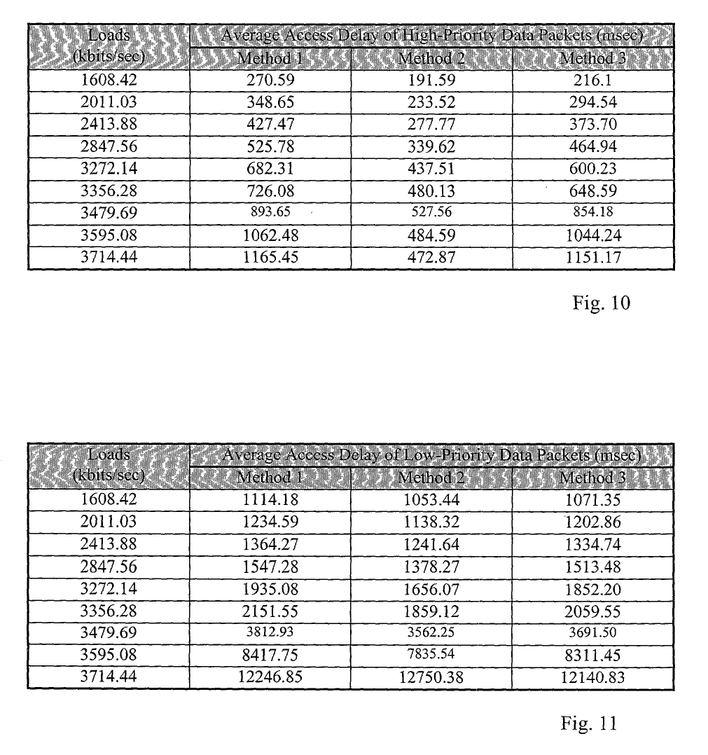

FIGS. 8-11 show simulation results for the first simulation scenario. FIG. 8 shows that the second variation provides a considerably lower average packet transfer delay to high-priority data traffic compared to the other two variations. Next, the third variation provides better packet transfer delay performance to high-priority data traffic compared to the first method up to approximately 89% traffic load. At high traffic loads, however, the third variation and the first variation provide a similar packet transfer delay performance to high-priority data traffic. FIG. 9 shows that all the three variations provide comparable packet transfer delay performance to low-priority data traffic.

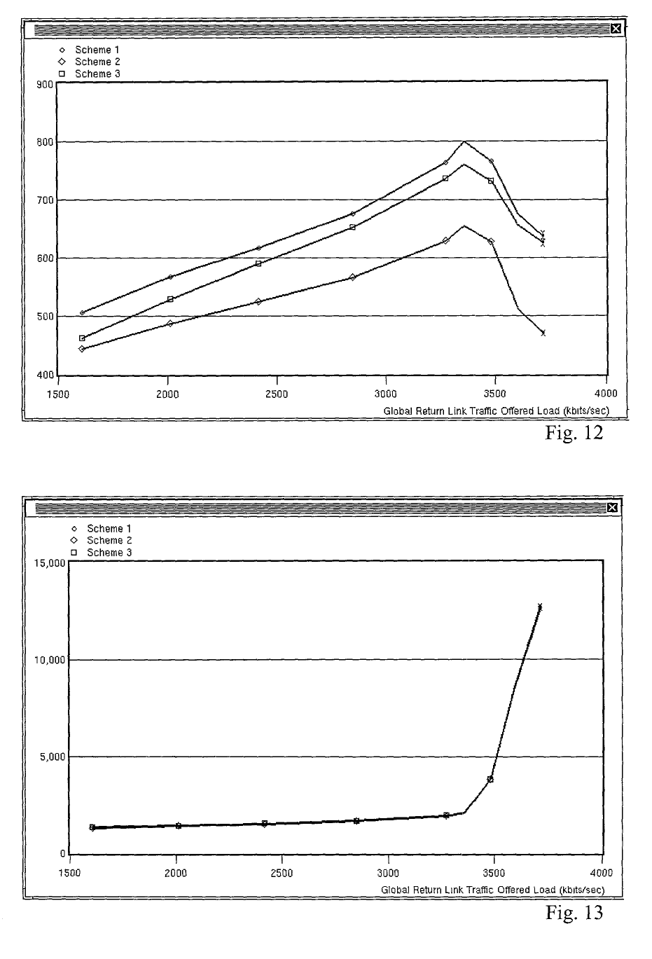

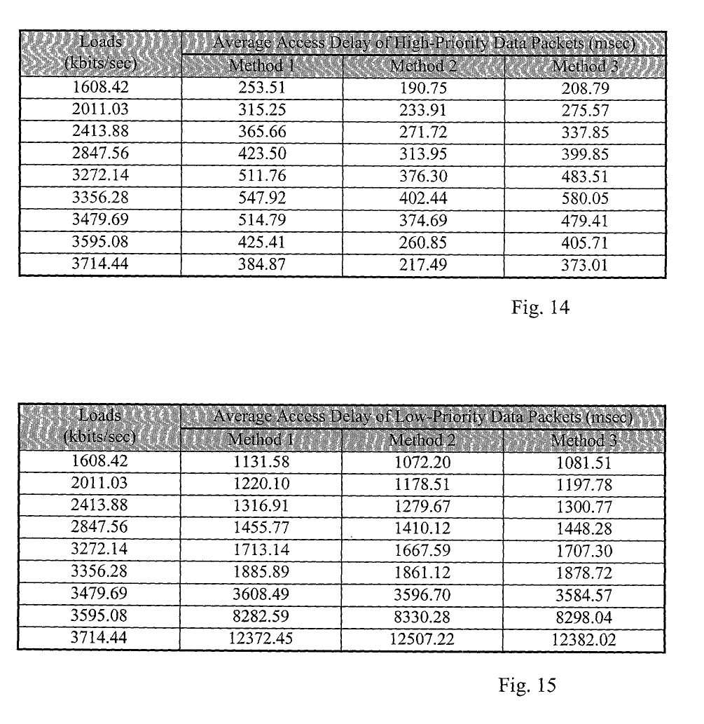

FIGS. 12-15 show simulation results for the second simulation scenario. FIG. 12 shows that the use of the VBDC prioritization feature in the resource allocation method of the present invention significantly improves packet transfer delay performance of high-priority data traffic for the first and third variations. This is because the VBDC prioritization feature enables the resource allocation server to grant data slots to more access devices at each frame. Therefore, each access device is given more request and transmission opportunities for its high-priority data traffic. For the case where the second variation is employed, the improvement in packet transfer delay performance is considerably lower, except for the case where traffic load is high.

An interesting point to note from FIG. 13 is that the average packet transfer delay of high-priority data traffic increases steadily for low to moderately high total traffic loads. At high traffic loads, however, the average packet transfer delay of high-priority data traffic reduces. In order to understand these results, first note that in all of the simulations, the average load of high-priority data traffic is maintained at approximately 20%. The total traffic load, however, is varied by increasing the load of low-priority data traffic. Next, note that since the VBDC credit of each access device is set at 1.0, an access device that always has pending VBDC requests (i.e., VBDC requests that have not been granted by the uplink scheduler) almost always receives a grant of at least one data slot at each frame. At high total traffic loads, due to the burstiness of low-priority data traffic, each access device almost always has pending VBDC requests. Thus, each access device is almost continuously granted a data slot at each frame. Since an access device devotes most of its data slot assignment to high-priority data traffic (recall that an access device can use up to 75% of data slots assigned to it to transport high-priority data traffic), most high-priority data traffic can be sent using this almost continuous grant of one data slot per frame. Thus, each device is able to send its high-priority data traffic quickly. As a result, packet transfer delay of high-priority data traffic reduces.

At low to moderately high total traffic loads, each access device does not continuously receive a grant of one data slot per frame. Hence, a higher proportion of high-priority data traffic has to be sent using its due requested data slot (i.e., data slots that are granted due to requests issued by a device for its high-priority data traffic). Therefore, the average packet transfer delay of high-priority data traffic increases as the total traffic load increases.

FIG. 13 further shows that performance improvement enjoyed by high-priority data traffic comes at little cost to low-priority data traffic. Comparing simulation results presented in FIG. 11 with those in FIG. 15 supports this observation.

In particular, it is an object of the present invention to improve upon bandwidth assignments, sustainable network throughput, data transfer delay, and user fairness by providing each registered terminal in a multi-user wireless communications network a set number of data slot credits at every frame and allowing such credits to accumulate from frame to frame in a manner that is directly proportional to the service rate of each terminal.

The above-described embodiments of the invention are intended to be examples of the present invention. Alterations, modifications and variations may be made to the particular embodiments by those of skill in the art, without departing from the scope of the invention which is defined solely by the claims appended hereto.

What is claimed is:

1. A resource allocation method for allocating data slots to access devices in a broadband telecommunications system operating under a combined free/demand assignment multiple access protocol, comprising in each frame:
(i) determining a number of reserved data slots for an access device;
(ii) receiving a volume-based dynamic capacity request from the access device;
(iii) determining a maximum prioritized volume-based dynamic capacity for the access device according to the volume-based dynamic capacity request and an accumulated prioritized volume-based dynamic capacity credit for the access device;
(iv) repeating (i) to (iii) for each of a plurality of access devices;
(v) determining a total available capacity for prioritized volume-based dynamic capacity;
(vi) allocating, to each of the plurality of access devices in turn up to their respective maximum prioritized volume-based dynamic capacities, prioritized volume-based dynamic capacity data slots until the total available capacity is exhausted; and
(vii) updating each of the plurality of access device's accumulated prioritized volume-based dynamic capacity credit.

2. The method of claim 1, wherein the number of reserved data slots are data slots reserved through constant rate allocation.

3. The method of claim 1, wherein the number of reserved data slots are data slots reserved according to rate-based dynamic capacity.

4. The method of claim 1, further including determining a maximum total volume-based dynamic capacity for each of the plurality of access devices.

5. The method of claim 4, further including allocating non-prioritized volume-based dynamic capacity data slots to each of the plurality of access devices if the available total capacity is not exhausted after the allocation of prioritized volume-based dynamic capacity data slots.

6. The method of claim 5, further including allocating free capacity assignment data slots after the non-prioritized volume-based dynamic capacity data slots have been allocated if free capacity remains.

7. The method of claim 5, wherein the allocation of free capacity assignment data slots includes the maintenance of a free capacity assignment credit for each of the plurality of access devices.

8. A resource allocation system for a broadband telecommunications network operating under a combined free/demand assignment multiple access protocol, comprising:
a circular-linked list for containing resource requirements for each of a plurality of access devices, the resource requirements including an accumulated volume-based dynamic capacity credit for each of the plurality of access devices;
a resource allocation server logically connected to the circular-linked list for receiving volume-based dynamic capacity requests from the plurality of access devices, and for scanning the circular-linked list to determine a number of reserved data slots for each of the plurality of access devices, to determine a maximum prioritized volume-based dynamic capacity for each of the plurality of access devices, to allocate, according to their respective volume-based dynamic capacity requests and accumulated prioritized volume-based dynamic capacity credits, prioritized volume-based dynamic capacity data slots until a total available capacity is exhausted, and, to update the accumulated prioritized volume-based dynamic capacity credits for each of the plurality of access devices.

9. The resource allocation system of claim 8, wherein the resource allocation server resides in a baseband section of a base station.

10. The resource allocation system of claim 8, wherein the circular-linked list includes a free capacity assignment credit for each of the plurality of access devices.
